(19) United States
(12) Patent Application Publication
(10) Pub. No.: US 2007/0003737 A1
(43) Pub. Date: Jan. 4, 2007

(54) Polymer to gold adhesion improvement by chemical and mechanical gold surface roughening

(76) Inventors: Rami Khalaf, Beaverton, OR (US); Ebrahim Andideh, Portland, OR (US); Caroline Merrill, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/173,608

(22) Filed: Jun. 30, 2005

(51) Int. Cl. B32B 3/00

(52) U.S. Cl. 428/172

(57) ABSTRACT

Polymer electronics devices having reliable electrical contacts and methods of their fabrication are described. A surface of a conductive layer is modified, and a layer of polymer is formed on a modified surface of the conductive layer to create an electrical contact between the conductive layer and the layer of polymer. The electrical contact is created without adding an adhesion promoter. Modifying the surface of the conductive layer increases surface area of conductive layer and therefore improves polymer to conductive layer adhesion while preserving an original chemistry of the surface of the conductive layer. The modified surface of the conductive layer may be formed by mechanical roughening, chemical roughening, or both. The conductive layer forming the electrical contact to the polymer includes a noble metal. The polymer may be spin coated over the modified surface of the conductive layer.

### FIELD

Embodiments of the invention relate generally to the field of fabrication of electronics devices, and more specifically, to polymer electronics devices.

### BACKGROUND

Competitive electronics manufacturing depends upon the development and integration of innovative and cost-effective device and materials technologies to create the diverse electrical and optical components and systems needed for tomorrow's electronics applications. Whether it is for memory or logic devices; optical or electrical interconnection, illumination or information displays; light or energy resources; detectors, sensors, or actuators; or lithography or molecular patterning, polymer electronics technologies, e.g., organic electronics, are emerging as viable technology options for creating new and improved electrical and optical systems and products. Generally, electronics devices are fabricated as chips, which include thin layers of various materials formed on top of one another. The adhesion between these layers needs to be strong enough for proper operation of the electronics device.

Unfortunately, the potential of polymer electronics devices remains unfulfilled, mostly because electrical contacts to polymers remain poor and unreliable which obviates use of the polymer electronics devices in many applications. To fabricate electrical contacts to polymers, noble metals may be used. Noble metals are resistant to chemical reactions, particularly to oxidation and to solution by inorganic acids. The adhesion of the polymers onto noble metals is weak due to chemically inactive nature of the noble metal. Typically, the adhesion strength of polymers onto noble metals, which may be measured as an interfacial fracture energy, is less than 1 J/m², which is much lower than the electronics industry value of at least 3.0 J/m² to enable product fabrication of electrical device. Currently, adhesion strength of polymers onto noble metals is not only unacceptable for wafer manufacturing of a polymer device but also for polymer device reliability. Accordingly, the electrical contacts to polymer, because of poor adhesion strength, are not able to withstand mechanical stresses or elevated temperatures. The polymer peels off the metal, cracks, or both. That is, the quality of the electrical contact between a noble metal and a polymer is poor that causes rapid degradation of electrical parameters of the contact. Currently, to increase the adhesion strength, insulating adhesion promoters, for example, produced by Rohm & Haas, Inc; JSR, Inc.; or SRI, Inc., are added between a polymer and a noble metal.

FIG. 1 is a side view 100 of a prior art electrical contact between a noble metal 101 and a polymer 102 with an adhesion promoter 103. As shown in FIG. 1, adhesion promoter 103 is added between noble metal 101 and polymer 102 to increase adhesion strength.

Addition of the adhesion promoter between the noble metal and polymer, however, significantly compromises the electrical performance of the electrical contact making it unacceptable for the electronics device operation. Furthermore, adding the adhesion promoters does not substantially improve the adhesion strength between the noble metal and polymer because of the chemically inert nature of the noble metal.

### BRIEF DESCRIPTION OF THE DRAWINGS

The invention may be best understood by referring to the following description and accompanying drawings that are used to illustrate embodiments of the invention. In the drawings:

FIG. 1 is a side view of a prior art electrical contact between a noble metal and a polymer with an adhesion promoter.

FIG. 2 is a side view of one embodiment of an electronics device having an electrical contact to a polymer.

FIG. 3A is a side view of a structure to fabricate an electronics device having an electrical contact to a polymer according to one embodiment of the invention.

FIG. 3B is a view similar to FIG. 3A, after surface of conductive layer is modified according to one embodiment of the invention.

FIG. 3C is a view similar to FIG. 3B, after surface of conductive layer is modified using mechanical and chemical means, according to one embodiment of the invention.

FIG. 3D is a view similar to FIG. 3C, after a layer of a polymer is formed on modified surface of conductive layer, according to one embodiment of the invention.

FIG. 4 is a side view of one embodiment of a polymer electronics device having an electrical contact to a polymer as described above with respect to FIGS. 2 and 3.

FIG. 5 is a flowchart of one embodiment of a method to form an electrical contact to a polymer.

FIG. 6 is a flowchart of another embodiment of a method to form an electrical contact to a polymer.

FIG. 7 is a flowchart of yet another embodiment of a method to form an electrical contact to a polymer.

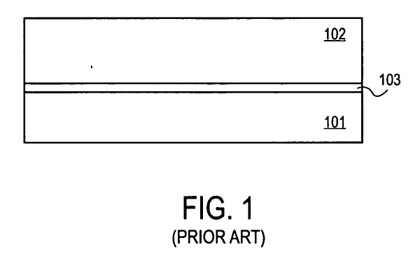

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Moreover, inventive aspects lie in less than all features of a single disclosed embodiment. Thus, the claims following the Detailed Description are hereby expressly incorporated into this Detailed Description, with each claim standing on its own as a separate embodiment of this invention.

Polymer electronics devices having reliable electrical contacts and methods of their fabrication are described herein. First, a surface of a conductive layer is modified, and then a layer of a polymer is formed without adding an adhesion promoter on a modified surface of the conductive layer to create an electrical contact between the conductive layer and the layer of polymer. The polymer is formed on the modified surface of the conductive layer without adding an adhesion promoter, such that the electrical performance of the polymer electronics device, for example, a ferroelectric polymer memory cell, at least is not compromised. Modifying the surface of the conductive layer is performed with preserving an original chemistry of the surface of the conductive layer. Further, modifying the surface of the conductive layer does not compromise performance of the electrical contact to be formed between the conductive layer and the layer of polymer later on in the process. In one embodiment, to modify the surface, roughening the surface of the conductive layer mechanically, chemically, or both, mechanically and chemically, may be performed. In one embodiment, the conductive layer may include a noble metal. In one embodiment, the layer of polymer may be formed on the conductive layer by spin coating the polymer over the conductive layer. Next, baking of the layer of polymer on the modified surface of the conductive layer may be performed.

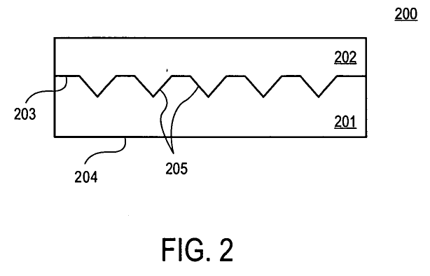

FIG. 2 is a side view 200 of one embodiment of an electronics device having an electrical contact to a polymer. As shown in FIG. 2, a conductive layer 201 has a top surface 203 and a bottom surface 204. As shown in FIG. 2, top surface 203 is modified, such that the length of the top surface 203 is larger than the length of bottom surface 204 to provide increased interface with a layer 202 of polymer. Top surface 203 has recesses 205 that provide anchors to layer 202 of polymer, as shown in FIG. 2. In one embodiment, conductive layer 201 includes a noble metal, or a noble metal containing alloy. In one embodiment, conductive layer 201 includes a metal, e.g., gold (“Au”), silver (“Ag”), tantalum (“Ta”), platinum (“Pt”), palladium (“Pd”), or any combination thereof. In one embodiment, the polymer of layer 202 is a fluorinated polymer including carbon, nitrogen and fluorine. In one embodiment, the polymer of layer 202 is a ferroelectric polymer, a piezoelectric polymer, or any combination thereof to fabricate a memory device. In one embodiment, the layer 202 of polyvinylidene fluoride-trifluoroethlene (“PVDF-TrEE”) is formed on conductive layer 201 of gold. In alternate embodiments, conductive layer 201 includes silver (“Ag”), gold (“Au”), nickel (“Ni”), titanium (“Ti”), aluminum (“Al”), zinc (“Zn”), titanium oxide (“TiO₂”), titanium nitride (“TiN”), or any other material known to one of ordinary skill in the art of electronics device fabrication to produce electrodes and layer 202 includes fluorinated polymer including carbon, nitrogen and fluorine.

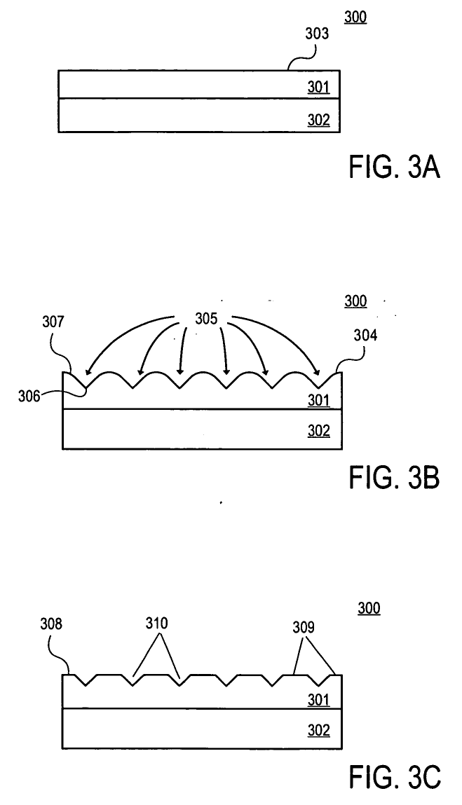

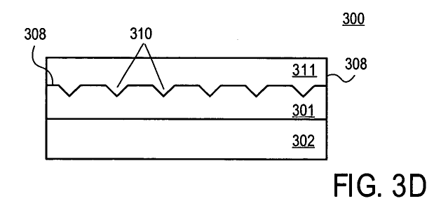

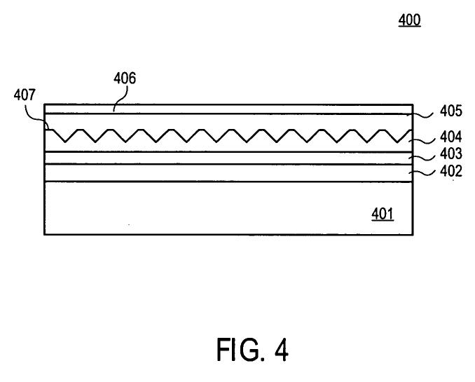

FIG. 3A is a side view 300 of a structure to fabricate an electronics device having an electrical contact to a polymer according to one embodiment of the invention. As shown in FIG. 3A, a conductive layer 301 is formed on a substrate 302. As shown in FIG. 3A, conductive layer 301 has surface 303, which has an original size and an original chemistry. The original chemistry of the surface of conductive layer 301 is the chemistry of surface 303 before modifying conductive layer 301 later on in the process. In one embodiment, conductive layer 301 is a noble metal, such as Au, Ag, Pt, Pd, or any combination thereof. In another embodiment conductive layer 301 is a noble alloy. In yet another embodiment, conductive layer 301 includes one or more metals known to one of ordinary skill in the art of electronics device fabrication. In one embodiment, substrate 302 includes a metal, e.g., titanium. In another embodiment, substrate 302 includes silicon. In yet another embodiment, conductive layer 301 is formed on a substrate 302 including silicon, silicon oxide, and one or more layers of metal, as described in further details below with respect to FIG. 4. In alternative embodiments, substrate 302 comprises any one, or a combination of, silicon, sapphire, silicon dioxide, silicon nitride, or other materials known to one of ordinary skill in the art of electronics device fabrication. In alternate embodiments, conductive layer 301 is formed on substrate 301 by sputtering, spin coating, deposition, or by using any other technique known to one of ordinary skill in the art of electronics device fabrication. In one embodiment, conductive layer of gold is sputtered onto substrate 301 comprising silicon. Sputtering techniques are known to one of ordinary skill in the art of electronics device fabrication. The thickness of conductive layer 301 is described in further details below with respect to FIGS. 3D and 4.

FIG. 3B is a view 300 similar to FIG. 3A, after surface 303 of conductive layer 301 is modified according to one embodiment of the invention. As shown in FIG. 3B, modified surface 304 has an increased surface area relative to the original area of surface 303. As shown in FIG. 3B, modified surface 304 has recesses 305, which provide anchors for a polymer formed on modified surface 304 later on in the process. Modified surface 304 has the original chemistry of surface 303, such that modifying the surface 303 does not compromise parameters of electrical contact formed later on in the process.

As shown in FIG. 3B, modified surface 304 has the roughness, which is typically defined as disruption of the planarity of the surface and is measured by the root-mean square (“rms”) of the surface variations between highest 307 and deepest 306 surface features. The roughness of modified surface 304 may be measured and controlled by Atomic Force Microscope (“ATM”). In one embodiment, the roughness of modified surface 304 of the conductive layer 301 of gold is at least 0.75 nm rms. In another embodiment, the roughness of modified surface 304 of conductive layer 301 of gold is in the approximate range of 3 nm rms to 9 nm rms. In one embodiment, the roughness of modified surface 304 of conductive layer 301 of gold is increased at least by a factor of 6 (“6×”) relative to the roughness of surface 303. In one embodiment, surface 303 is modified using mechanical roughening techniques, chemical roughening techniques, or a combination thereof. In one embodiment, modified surface 304 is formed by mechanical roughening of surface 303, e.g., scratching, or polishing. Techniques to perform mechanical roughening of surface 303 are known to one of ordinary skill in the art of electronics device fabrication. In one embodiment, modified surface 304 is formed by chemical-mechanical polishing (“CMP”) technique with a chemistry, which preserves original chemistry of surface 303. That is, the chemistry to perform CMP does not leave any residue, debris, chemical compounds, and/or impurities on modified surface 304, which can not be removed from modified surface 304 before forming a polymer layer later on in the process. In one embodiment, surface 303 of gold is modified by CMP technique using a periodic acid based slurry (acid derived from I₂O₇ by the addition of water molecules, as HIO₄ or H₅I). The CMP techniques are known to one of ordinary skill in the art of electronics device fabrication. In another embodiment, modified surface 304 is formed by etching surface 303 of conductive layer 301 of gold with a chemistry, which does not change the original chemistry of surface 303. That is, the chemistry to perform etching of surface 303 does not create residue, debris, chemical compounds, and/or impurities on modified surface 304, which can not be removed from modified surface before forming a polymer layer later on in the process. The etching chemistry etches around a grain structure of the material of conductive layer 301, which results in broader and deeper boundaries between grains that creates recesses 305, as shown in FIG. 3B. In one embodiment, surface 303 of conductive layer 301 of gold is wet etched with potassium iodine (“KI”) to form modified surface 304 with recesses 305. In one embodiment, KI-based etching solution is sprayed onto surface 303 of conductive layer 301 of gold to perform wet etching. In one embodiment, surface 303 is modified by dry etching. In another embodiment, surface 303 is modified by a combination of wet and dry etching. Techniques for dry and wet etching are known to one of ordinary skill in the art of electronics device fabrication.

FIG. 3C is a view 300 similar to FIG. 3B, after surface 303 of conductive layer 301 is modified using mechanical and chemical means, according to one embodiment of the invention. As shown in FIG. 3C, modified surface 308 of conductive layer 301 has flat tops 309 and recesses 310, which provide anchors for a polymer formed on modified surface 308 later on in the process. As shown in FIG. 3C, because of flat tops 309, modified surface 308 has even greater surface area than modified surface 304. In one embodiment, to form modified surface 308, surface 303 is roughened using chemical-mechanical polishing (“CMP”) and wet etching. In one embodiment, surface 303 of conductive layer 301 of gold is first roughened by chemical-mechanical polishing using KI-based slurry, and then wet etched using KI-based etching solution. In another embodiment, surface 303 of conductive layer 301 of gold is first wet etched using KI-based etching solution, and then chemically-mechanically polished with KI-based slurry. In one embodiment, after roughening, modified surface 304 of conductive layer 301 is cleaned to remove debris from modified surface 304. Debris may be wiped or rinsed off the modified surface 304 using a technique known to one of ordinary skill in the art of electronics device fabrication. Modified surface 308 has the original chemistry of surface 303.

FIG. 3D is a view 300 similar to FIG. 3C, after a layer 311 of a polymer is formed on modified surface 308 of conductive layer 301, according to one embodiment of the invention. Layer 311 of the polymer is formed on modified surface 308 to create an electrical contact between the polymer and conductive layer 301. As shown in FIG. 3D, modified surface 308 produces an increased interface between conductive layer 301 and layer 311. As shown in FIG. 3D, layer 311 of the polymer fills recesses 310 that provides intermixing of layer 311 of polymer and conductive layer 301 at the increased interface between the conductive layer 301 and layer 311 that substantially increases the adhesion strength. In one embodiment, the surface of conductive layer 301 of gold is modified by CMP using a periodic acid based slurry (acid derived from I₂O₇ by the addition of water molecules, as HIO₄ or H₅I) and then wet etched with KI solution to form modified surface 308 having the roughness of at least 0.75 nm rms, which defines the depth of recesses 310. As shown in FIG. 3D, recesses 310 in modified surface 308 provide anchors for layer 311. In one embodiment, the roughness of modified surface 304 is such that the adhesion strength between conductive layer 301 and layer 311 of the polymer is at least 3 J/m². In one embodiment, layer 311 of the polymer may be spin coated onto modified surface 308 of conductive layer 301 of gold, such that the polymer is flowed into recesses 310. In alternate embodiments, layer 311 of polymer may be formed on modified surface 308 using other techniques known to one of ordinary skill in the art of electronics device fabrication. In one embodiment, the polymer of layer 311 is a fluorinated polymer including carbon, nitrogen, and fluorine. In one embodiment, the polymer of layer 311 is a ferroelectric polymer, a piezoelectric polymer, or both, which may be used to fabricate a memory device. In one embodiment, the polymer of layer 311 includes polyvinylidene fluoride-trifluoroethlene (“PVDF-TrEE”) and conductive layer 301 includes a noble metal, e.g., gold. In one embodiment, layer 311 of the polymer may have the thickness in the approximate range of 100 angstroms (“A”) to 2000 Å and conductive layer 301 of gold with a modified surface may have the thickness in the approximate range of 100 Å to 2000 Å. More specifically, layer 311 of the polymer may have the thickness between 650 Å to 1100 Å and conductive layer 301 of gold with a modified surface may have the thickness about 1000 Å.

Next, layer 311 of the polymer on the modified surface of the conductive layer 301 is annealed (“baked”) to align polymer chains for polymer to become viscoelastic. Viscoelastic polymer has domains of polymer chains aligned to one another. In one embodiment, layer 311 of the polymer on the modified surface of the conductive layer 301 is annealed at the temperature in the approximate range of 80 C to 150 C for approximately 1 to 2 minutes. More specifically, the temperature of annealing is in the approximate range of 125 C to 140 C and time of annealing is about 90 seconds. Annealing techniques are known to one of ordinary skill in the art of electronics device fabrication.

FIG. 4 is a side view 400 of one embodiment of a polymer electronics device having an electrical contact to a polymer as described above with respect to FIGS. 2 and 3. As shown in FIG. 4, a polymer electronics device includes a substrate 401. Substrate 401 may be one of the substrates described above with respect to FIG. 3A. As shown in FIG. 4, insulating layer 402 is formed on substrate 401. In one embodiment, insulating layer 402 may be silicon oxide formed on substrate 401 of monocrystalline silicon. Insulating layer 402 may be formed on substrate 401 using one of techniques known to one of ordinary skill in the art of electronics device fabrication, e.g., by oxidation, or chemical vapor deposition (“CVD”). In one embodiment, insulating layer 402 of silicon oxide formed on substrate 401 of monocrystalline silicon may have the thickness in the approximate range of 1000 Å to 4000 Å, and more specifically, about 2000 Å. As shown in FIG. 4, conductive layer 403 is formed on insulating layer 402. In one embodiment, conductive layer 403 is a metal, e.g., Ti, Ni, Zn, Ag, or any other metal known to one of ordinary skill in the art of electronics device fabrication. In one embodiment, conductive layer 403 of Ti is formed on insulating layer 402 of silicon oxide on substrate 401 of monocrystalline silicon. Conductive layer 403 of Ti may have the thickness in the approximate range of 200 Å to 400 Å, and more specifically, about 360 Å. Next, conductive layer 404 is formed on conductive layer 403, as shown in FIG. 4. Conductive layer 404 may be formed by sputtering, deposition, or any other techniques known to one of ordinary skill in the art of electronics device fabrication. In an embodiment, conductive layer 404 includes any material described above with respective to conductive layer 301 of FIGS. 3A-3D. In one embodiment, conductive layer 404 of gold having the thickness in the approximate range of 500 Å to 2000 Å, and more specifically, between 800 Å to 1000 Å, is formed on conductive layer 403 of Ti. Conductive layer 404 may be formed using a technique described above with respect to FIG. 3A, e.g., using the sputtering.

As shown in FIG. 4, conductive layer 404 has a surface 407 with recesses. Surface 407 is modified as described above with respect to FIGS. 3B and 3C. A layer 405 of a polymer is formed on conductive layer 404, as described above with respect to FIG. 3D. In one embodiment, layer 405 of the polymer has the thickness in the approximate range of 500 Å to 2000 Å, and more specifically, in the approximate range of 650 Å to 1100 Å. As shown in FIG. 4, conductive layer 404 forms a bottom electrode to the polymer. In one embodiment, conductive layer 404 has the adhesion strength to layer 405 of polymer of at least 3.5 J/m² without compromising electrical performance of the polymer electronic device. In one embodiment, conductive layer 406 may be formed on layer 405 of the polymer to form a top electrode to the polymer. In one embodiment, conductive layer 406 is a metal, e.g., Ag, Au, Ni, Ti, Al, Zn, or any combination of metals known to one of ordinary skill in the art of electronics device fabrication.

In one embodiment, conductive layer 406 of gold may be formed on layer 405 of the polymer. The thickness of conductive layer 406 of gold may be in the approximate range of 200 Å to 600 Å, and more specifically, about 400 Å. In one embodiment, conductive layer 406 may be deposited onto layer 405 of polymer. The depositing technique, e.g., sputtering or chemical vapor deposition, is known to one of ordinary skill in the art of electronics device fabrication.

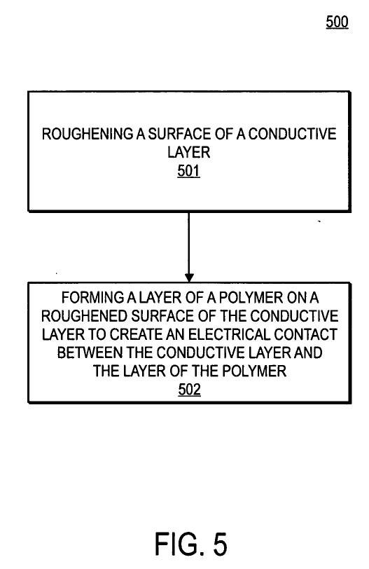

FIG. 5 is a flowchart of one embodiment of a method to form an electrical contact to a polymer without compromising the electrical performance of an electronics device. As shown in FIG. 5, the method begins with operation 501 of roughening a surface of a conductive layer, as described above with respect to FIGS. 3B and 3C. The method continues with operation 502 of forming a layer of a polymer on a roughened surface of the conductive layer to create the electrical contact between the conductive layer and the layer of the polymer, as described above with respect to FIG. 3D.

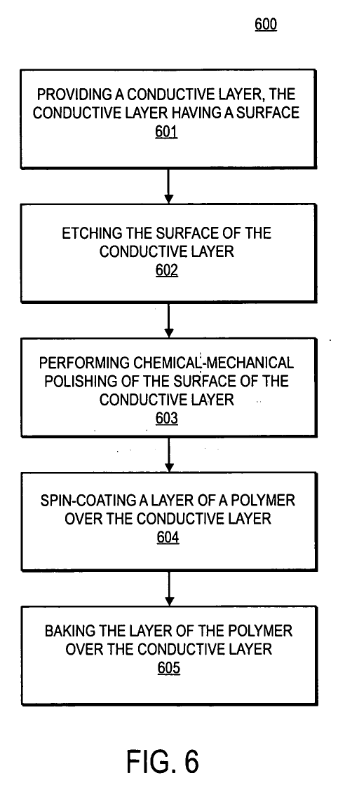

FIG. 6 is a flowchart of another embodiment of a method to form an electrical contact to a polymer without compromising the electrical performance of an electronics device. As shown in FIG. 6, the method begins with operation 601 of providing a conductive layer, the conductive layer having a surface. Next, in operation 602, etching the surface of the conductive layer is performed as described above with respect to FIGS. 3B and 3C. The method continues with operation 603 of chemical-mechanical polishing of the surface of the conductive layer, as described above with respect to FIGS. 3B and 3C. Next, in operation 604, a layer of a polymer is spin-coated over the conductive layer, as described above with respect to FIG. 3D. Next, in operation 605, annealing (“baking”) the layer of the polymer on the conductive layer is performed, as described above with respect to FIG. 3D.

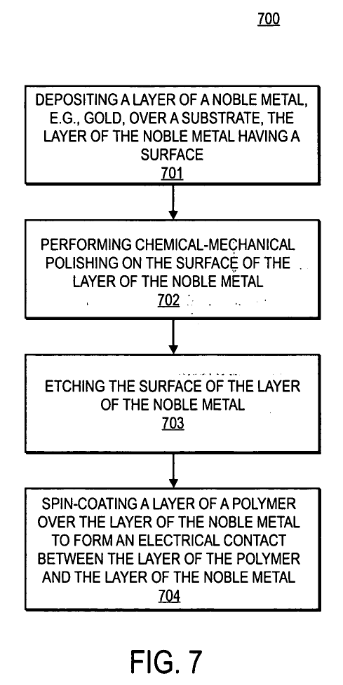

FIG. 7 is a flowchart of yet another embodiment of a method to form an electrical contact to a polymer without compromising the electrical performance of an electronics device. As shown in FIG. 7, the method begins with operation 701 of depositing a layer of noble metal, e.g., gold, over a substrate, the layer noble metal having a surface. The method continues with operation 702 of performing chemical-mechanical polishing the surface of the layer of noble metal, as described above with respect to FIGS. 3B and 3C. Next, in operation 703, the surface of the layer of noble metal is etched using, e.g., potassium iodine, as described above with respect to FIGS. 3B and 3C. Further, the method continues with operation 704 of spin-coating a layer of a polymer over the modified surface of the layer of noble metal to form the electrical contact between the layer of polymer and the layer of noble metal without compromising electrical performance of the electronics device, as described above with respect to FIG. 3D.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method to adhere a polymer to a conductive layer, comprising:
modifying a surface of the conductive layer;
forming a layer of the polymer on a modified surface of the conductive layer, to create an electrical contact between the conductive layer and the layer of the polymer, wherein the modifying preserves an original chemistry of the surface of the conductive layer.

2. The method of claim 1, wherein the modifying increases the surface area of the conductive layer and provides anchors for the polymer.

3. The method of claim 1, wherein the modifying the surface of the conductive layer preserves an electrical performance of the electrical contact between the conductive layer and the layer of the polymer.

4. The method of claim 1, wherein the modifying the surface of the conductive layer is performed to provide the roughness of the surface of at least 0.75 nm rms.

5. The method of claim 1, wherein the modifying comprises
chemical-mechanical polishing the surface of the conductive layer and
etching the surface of the conductive layer.

6. The method of claim 1, wherein the conductive layer includes a metal.

7. The method of claim 1, wherein the polymer is a ferroelectric.

8. The method of claim 1, wherein the forming the layer of the polymer comprises
spin coating the polymer over the conductive layer.

9. The method of claim 1, further comprising
baking the layer of the polymer on the roughened surface of the conductive layer.

10. A method to form a polymer electronics device, comprising:
forming a conductive layer over a substrate, the conductive layer having a surface;
roughening the surface of the conductive layer; and
forming a layer of a polymer on the conductive layer.

11. The method of claim 10, wherein an original chemistry of the surface of the conductive layer is preserved after the roughening.

12. The method of claim 10, wherein the roughening includes
chemical-mechanical polishing the surface of the conductive layer.

13. The method of claim 10, wherein the roughening includes
etching the surface of the conductive layer.

14. The method of claim 10, wherein the roughening comprises
chemical-mechanical polishing the surface of the conductive layer, and
after the chemical-mechanical polishing, etching the surface of the conductive layer.

15. The method of claim 10, wherein the conductive layer includes a noble metal.

16. The method of claim 10, wherein the polymer is a ferroelectric.

17. The method of claim 10, wherein the forming the layer of the polymer comprises
spin coating the polymer over the conductive layer.

18. The method of claim 10, further comprising
baking the layer of the polymer on the roughened surface of the conductive layer.

19. The method of claim 10, wherein the roughening the surface of the conductive layer increases an interface area between the conductive layer and the layer of the polymer.

20. The method of claim 10, wherein the roughness of the surface of the conductive layer is at least 0.75 nm rms.

21. An apparatus, comprising:
a conductive layer, having a roughened surface and recesses in the roughened surface; and
a layer of a polymer on the roughened surface of the conductive layer, wherein conductive layer provides an electrical contact to the layer of the polymer.

22. The apparatus of claim 21, wherein the polymer fills the recesses in the roughened surface of the conductive layer.

23. The apparatus of claim 21, wherein the roughness of the surface of the conductive layer is at least 0.75 nm rms.

24. The apparatus of claim 21, wherein the conductive layer includes a noble metal.

25. The apparatus of claim 21, wherein the polymer is a ferroelectric.

26. A polymer electronics device, comprising:
a substrate;
an insulating layer over the substrate;
a first conductive layer on the insulating layer;
a second conductive layer over the first conductive layer, the second conductive layer having a roughened surface; and
a layer of a polymer on the roughened surface of the second conductive layer.

27. The device of claim 26, wherein the second conductive layer provides an electrical contact to the layer of the polymer.

28. The device of claim 26, wherein the second conductive layer includes a noble metal.

29. The device of claim 26, wherein the layer of polymer is a ferroelectric.
